(19) United States
(12) Patent Application Publication
(10) Pub. No.: US 2019/0296907 A1
(43) Pub. Date: Sep. 26, 2019

(54) BLOCKCHAIN FOR TIME-BASED RELEASE OF INFORMATION

(71) Applicant: CA, Inc., New York, NY (US)

(72) Inventors: Steven Cornelis VERSTEEG, Ivanhoe (AU); John Sinclair BIRD, Ringwood (AU); Deborah Anne VETHECAN, Bulleen (AU)

(73) Assignee: CA, Inc.

(21) Appl. No.: 15/934,560

(22) Filed: Mar. 23, 2018

(51) Int. Cl. H04L 9/08; G06F 21/62

(52) U.S. Cl. CPC H04L 9/0894; H04L 9/0643; H04L 9/0825; G06F 21/6245

(57) ABSTRACT

A method includes distributing a plurality of key pieces associated with an encryption key to a plurality of key piece holders, adding release data to a blockchain database including sensitive data encrypted with the encryption key and a specified release date. The method further includes providing instructions to key piece holders to add respective key pieces to the blockchain database at the specified release date to facilitate time-based release of the sensitive data.

### BACKGROUND

The disclosure relates generally to blockchain technology, including method and systems for storing and releasing information using blockchain technology, and more specifically to a blockchain mechanism for time-based release of information.

### BRIEF SUMMARY

According to one aspect of the present disclosure, a method includes distributing a plurality of key pieces associated with an encryption key to a plurality of key piece holders, adding release data to a blockchain database including sensitive data encrypted with the encryption key and a specified release date. The method further includes providing instructions to key piece holders to add respective key pieces to the blockchain database at the specified release date to facilitate time-based release of the sensitive data.

### BRIEF DESCRIPTION OF THE DRAWINGS

Aspects of the present disclosure are illustrated by way of example and are not limited by the accompanying figures with like references indicating like elements.

FIG. 1 illustrates split encryption key creation and encryption.

FIG. 2 illustrates a distribution of key pieces.

FIG. 3 illustrates a high-level representation of a segment of a blockchain database and blockchain blocks.

FIG. 4 illustrates a high-level representation of key pieces being added to the blockchain of FIG. 3.

FIG. 5 illustrates an alternative high-level representation of key pieces being added to the blockchain database of FIG. 3.

FIG. 6 illustrates a key holder reconstructing a secret key from the key pieces added to the blockchain database of FIG. 5.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Time based release of information is a technique for controlled delivery of information. As observers of the field appreciate, blockchain technologies are beginning to gain recognition for providing innovative solutions for handling the transfer and release of information. The methods and systems described herein provide techniques and systems for releasing information at a scheduled time while simultaneously requiring cooperation to derive a private or secret key to decrypt sensitive information. The embodiments described herein achieve secure release of information at specific times using a blockchain network as a trusted keeper of information. Generally speaking, the systems and methods herein involve distributing segments of a private key needed to decrypt a document that was written to the blockchain to a number of parties with instructions to unlock the document after a specified time by adding the key pieces to the blockchain database at a specified time, thereby facilitating cooperative derivation of the private key used to encrypt the document to provide for decryption of the document. Given the varying needs for the secure release of information at specific times, the systems and methods described herein facilitate such release in a way that ensures both the security of the information, due to proof-of-work mechanisms of the blockchain protocol and the guarantee that information will be made available upon the specified time by enabling its decryption at the specified time.

Techniques for using a blockchain in an attempt to release information on the basis of time have been attempted. For example, some have attempted to facilitate the release of information at a specific time by conditioning the release of information when a specific number of blocks have been written to a blockchain. Thus, in these attempts, the architecture is wholly dependent on the blockchain protocol and the proof-of-work constraints, where the private keys are only derivable from future blocks. While piggybacking on the Bitcoin network is efficient by making use of resources that are already being expended and is cryptographically secure, these systems do not allow for precision in the release of information based on time.

Rather than being rooted in a future block on the network, the embodiments herein provide for release precisely at the specified time when the key pieces are added to the blockchain itself. The Bitcoin protocol is designed so that a block will be created only roughly every ten minutes depending on the difficulty of the proof-of-work target hashing puzzle. This means that some blocks may be added to the chain faster than others (slightly less than ten minutes), while other blocks may be added to the blockchain slower than others (greater than ten minutes). The more time that passes, the greater the margin for error thus grows, as keys may be derived in a delayed fashion. When the key cannot be derived in a timely manner, the information cannot be accessed in a timely manner either, as it cannot be accessed upon the specified time. If keys are derived too fast, by blocks being created too fast, then the security of the information may be compromised by early release of information.

Other techniques for release of information based upon time operate on the premise that encrypted information can be decrypted by a key that is only revealed upon completion of computational puzzles. The computational puzzles may be made difficult to varying degree, so that a precise amount of time is required for them to be solved, and thus the information is subject to release upon a certain amount of time having elapsed. However, these systems make assumptions about computing speed, and thus it is difficult to specify an exact amount of time. Further, the design is limited if the intended time for decryption is made too far into the future.

The design of the systems and methods described herein differ in that it can guarantee the release of information at a specific and fixed time as a result of the architecture. As the time for data release is specifically encoded into the blockchain itself, information can be guaranteed to be released at the exact prescribed time, upon derivation of the private key to firstly decrypt the document.

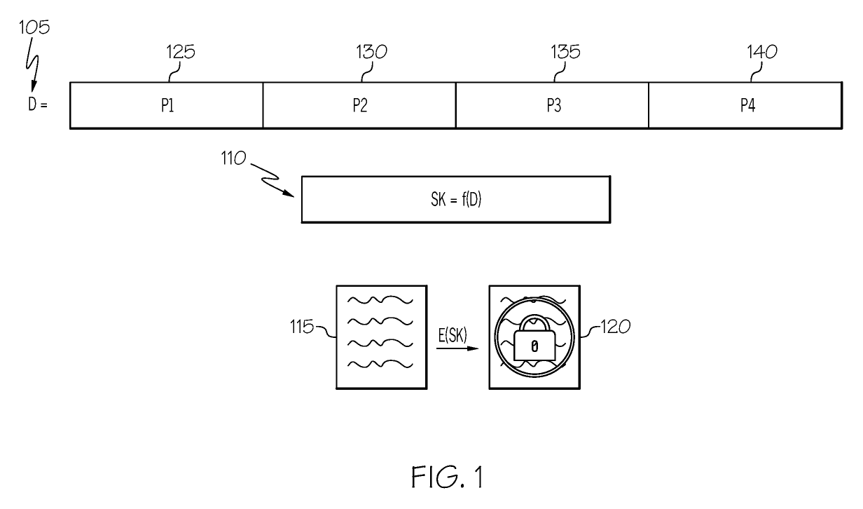

As discussed above, the systems and methods described herein involve the use and distribution of key pieces that are used to derive an encryption key. Referring to FIG. 1, a secret key 110 may be derived from a collection of key pieces 105, the collection being a vector for example, using a deterministic key derivation function. As illustrated in FIG. 1, the key piece vector comprises four key pieces 125, 130, 135, and 140, which collectively comprise the collection of key pieces 105. In some embodiments, fewer or more than four key pieces may be utilized and recommended. The deterministic key derivation function may be a split-key derivation function using a threshold encryption scheme such that all of the key pieces are inputs in deriving the secret key, but the secret key may be reconstructed from a subset of the key pieces using the key derivation function. The quantity of key pieces necessary for reconstruction may vary in different embodiments and in some embodiments all key pieces may be necessary. However, whichever threshold quantity is utilized, using such a deterministic key derivation function with less than the threshold quantity of key pieces reveals no information about the secret key.

Generally speaking, sharing of a split key refers to methods distributing pieces or segments of a secret such as a vector or input to a encryption key derivation function. Using these key splitting encryption techniques, the input to the encryption key derivation function can only be reconstrued when a sufficient number of the pieces are combined together. Individually, the key pieces are useless, but when combined they may be used to reconstruct a secret encryption key. Split key encryption is often utilized together with threshold schemes such that only a threshold of the pieces are needed to reconstruct he secret key. Key sharing schemes and threshold schemes are important in cloud computing and distributed environments. In these environments, key pieces can be distributed over several resources including users, servers, or other connected entities. One such scheme is referred to as Shamir's Secret Sharing, however, one of skill in the art would appreciate other schemes for sharing the pieces of the secret key.

With a secret key 110 derived from the collection of key pieces 105, a sensitive document 115 can be encrypted with the secret key 110, thereby resulting in an encrypted sensitive document 120. The encrypted document may contain information that the author wants to make visible only after a specific period of time has elapsed and may be encoded in such a way that it cannot be decrypted before that time has expired.

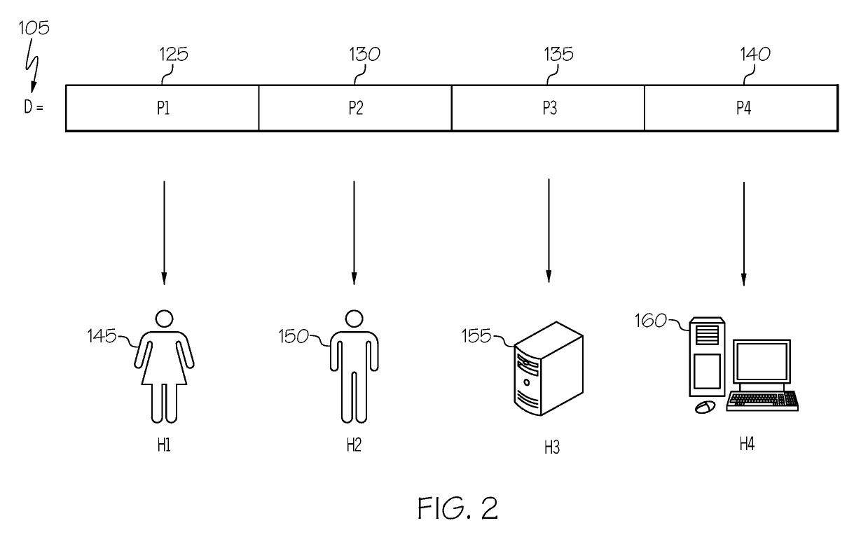

In some embodiments, each of the key pieces may be distributed to key piece holders. Thus, referring to FIG. 2 and continuing with the example, the four key pieces 125, 130, 135, and 140 may each be distributed to a plurality of key piece holders. In some embodiments, each key piece is distributed to a different key piece holder, as is illustrated in FIG. 2. In other embodiments, the key pieces are held by at least two different key piece holders. Key piece holders may be individuals, such as key piece holder 145 and key piece holder 150, servers such as server 155, or network nodes such as node 160. In some embodiments, some or all of the key piece holders may be automated services such as web applications. Instructions may be provided to the key piece holders to reveal their piece of the key piece vector at the specified time and not earlier. If the key piece holders are automated services such as web applications, the instructions may comprise computer code that is operable to cause the automated service to execute the given instructions. The embodiments described herein assume that at least a threshold quantity of the key piece holders are honest. In some embodiments, the threshold quantity of honest key piece holders and the threshold quantity of key pieces needed to reconstruct the secret key may be the same. Thus, in such embodiments, these thresholds may be set to correspond to the assumed number of honest key piece holders available. While no key piece should be given to a party known to be untrusted, the thresholds and assumptions make the system robust enough to handle dishonest holders.

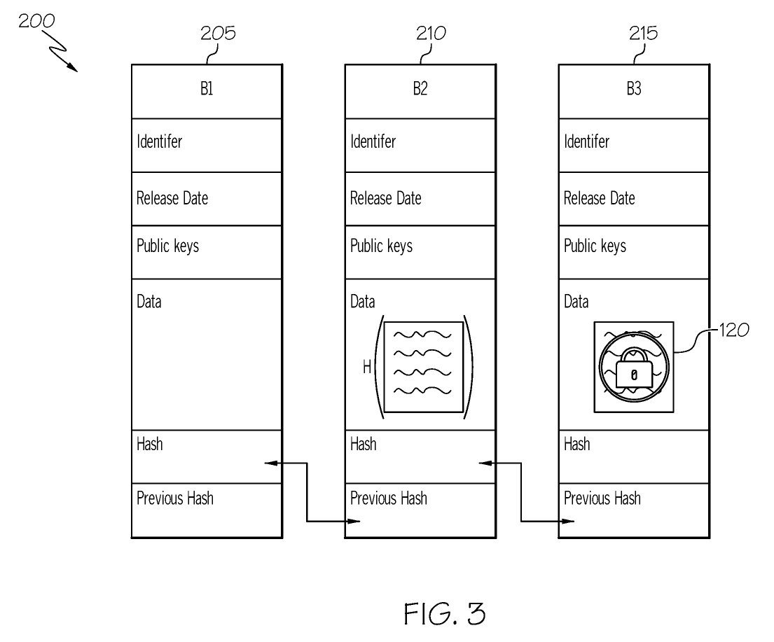

Referring to FIG. 3, the embodiments herein may add release information to a blockchain database, such as blockchain database 200. The encrypted document 120 may be written directly onto the blockchain, as illustrated in block 215, or stored at another publicly accessible location, with a hash of the document written to the blockchain, as illustrated in block 210. In addition, the specific time for release data may be written onto the blockchain itself to ensure the document's release, as show in blocks 205, 210, and 215. Some embodiments may also write the public keys of each of the key piece holders who hold the key pieces needed to derive the secret key to the blockchain, as shown in blocks 205, 210, and 215. This release information may be added to a block on the blockchain database along with other block information including the block header and block data. For example, as shown in FIG. 3, the blocks may comprise an identifier, a release date and time, public keys of key holders, block data such as encrypted secret data, a hash value of the block, and the hash value of the previous block, which may be referred to as a hash pointer.

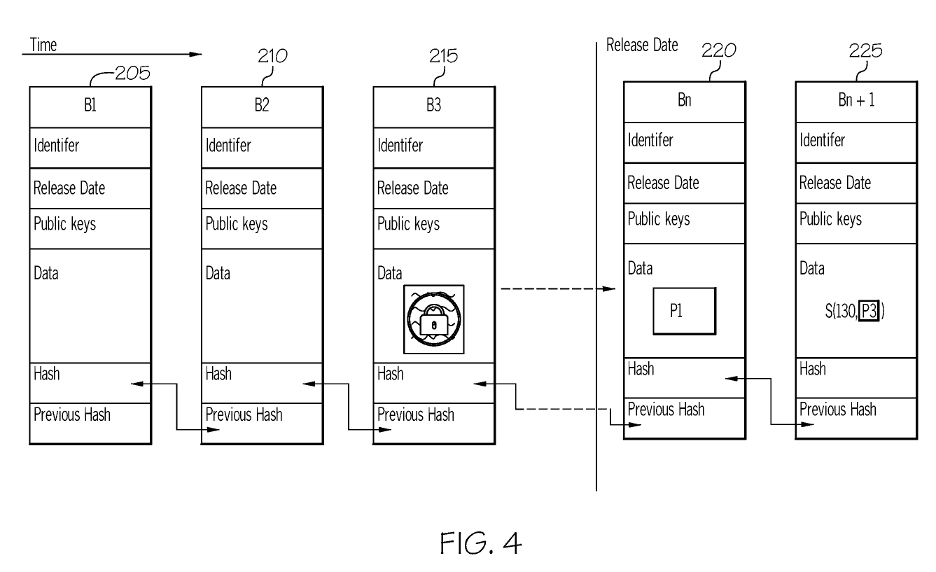

Referring to FIG. 4, when the date and time for release have expired and the document is now to be released for decryption so that its contents can be viewed, the keyholders may cooperate amongst themselves to derive the secret key needed to decrypt the document. In some embodiments, each party holding a key piece is instructed to write their piece to the blockchain. For example, the embodiment in FIG. 4 shows that two key pieces, 125 and 130, were added to the blockchain after the release date in blocks 220 and 225, respectively. In some embodiments, each party will sign their key piece with their own private key so that he authenticity of the piece can be verified, as shown by example in block 225. Once at least the threshold quantity of key pieces are added to the blockchain, any actor with access to the blockchain can then derive the secret key and decrypt the document.

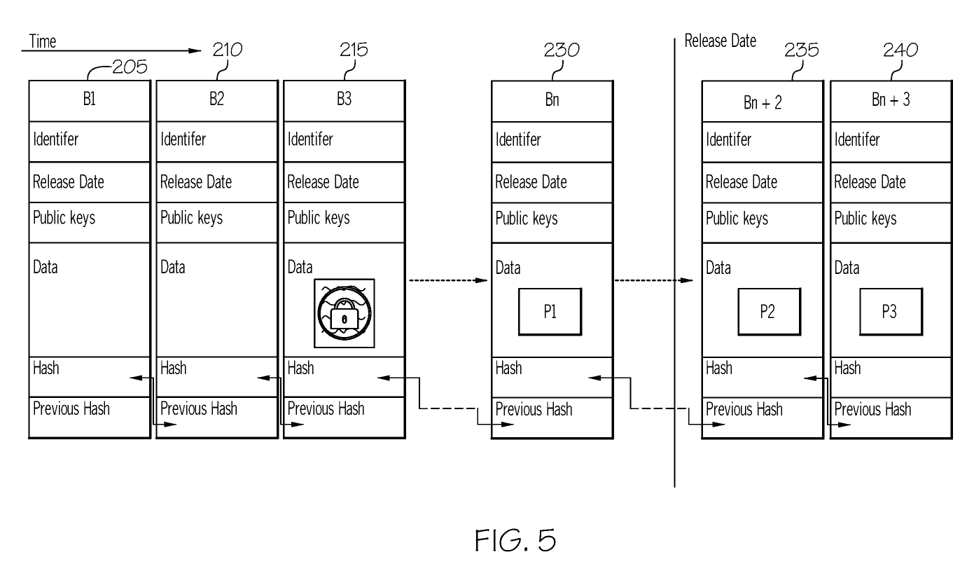

Referring now to FIG. 5, and supposing the threshold quantity of key pieces needed to reconstruct the secret key is three out of four total key pieces in this example, one can see that key holder 145, who held key piece 125 (P1) added her key piece to the blockchain prior to the specified release date. However, at that time, the encoding of the document and the blockchain would not permit the encrypted document in block 215 from being decrypted because the release date has not expired, and the threshold quantity of key pieces had not yet been added to the blockchain. In this example, key piece holder 145 may be dishonest or their key may have been compromised by other means. Whatever the situation, the encrypted document has not been compromised by the early release of one of the four key pieces in this example. FIG. 5 shows however that key piece holders 150 and 155, who held key pieces 130 and 135 respectively, added their key pieces to the blockchain after the release time expired.

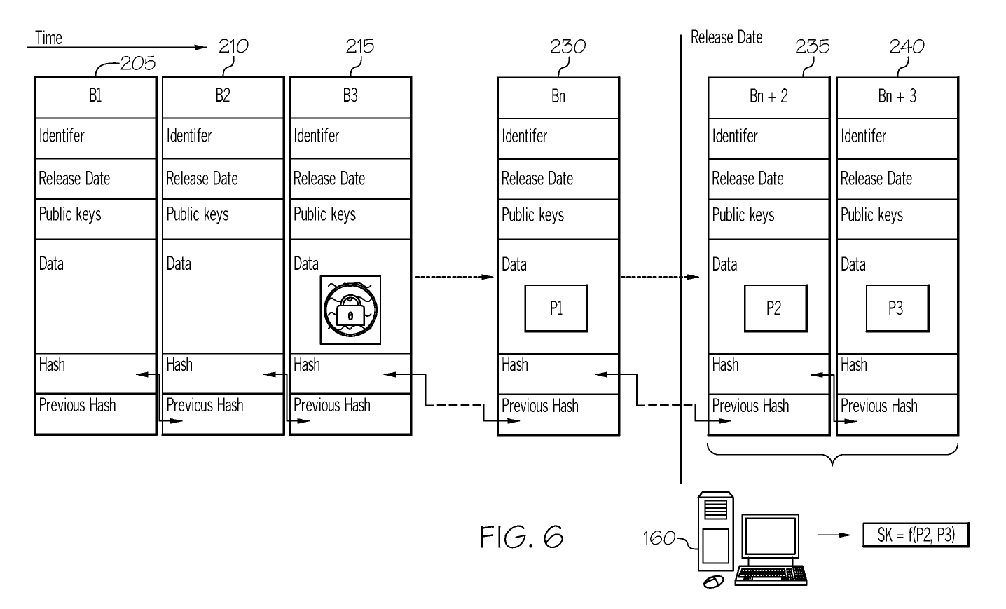

Therefore, referring now to FIG. 6, key piece holder 160 is able to derive secret key after the release date has expired by obtaining key piece 130 and key piece 135, using the key derivation function with a threshold quantity of the key pieces as inputs to reconstruct the secret key and decrypt the encrypted document written to the blockchain in block 215.

One of skill in the art would appreciate that the systems and methods herein have useful application in public and private blockchains. Regarding private blockchains for example, a small group of key holders or persons to whom are intended to obtain the encrypted data have access to the blockchain. Thus, when the threshold quantity of key pieces become available on the blockchain, only those who are intended to decrypt it may do so. Regarding public blockchains for example, which may be appropriate given the application of the systems described herein, information may become publicly available once the threshold quantity of key pieces are added to the blockchain.

More specifically, the present systems and methods described herein may facilitate and be used in monthly mortgage repayment schemes or other repayment scenarios, escrow schemes, time-sensitive bidding schemes, or even time capsule schemes, such as an encrypted dairy to become public in fifty years, for example. These use cases involve data transfers which must be achieved strictly upon specified times; otherwise, such cases are rendered compromised or futile if the information is released either too early or too late. With respect to public release of information, possible government uses regarding declassification of documents, for example, would benefit from the systems described herein. In the United States, for example, many government documents must be released to the public after a set period of time such as twenty-five years. If such documents were written or attached to the blockchain of the present disclosure, invested parties can be guaranteed of the release of information.

In one embodiment, a method may derive an encryption key from a plurality of key pieces using an encryption function that is configured to allow the encryption key to be determined or reconstructed on or after the specified release date using fewer than all of the plurality of key pieces, and may involve encrypting the sensitive data with the encryption key.

The method may include distributing a first key piece of a plurality of key pieces to a first key piece holder of a plurality of key piece holders. Each of the plurality of key pieces may be associated with an encryption key. Referring to the discussion above, each of the plurality of key pieces may have been used to derive a secret key that may be used to encrypt sensitive data. In one embodiment, as key piece of the plurality of key pieces may be distributed to a second key piece holder of the plurality of key piece holders. The first and second key piece holders may be different key piece holders of the plurality of key piece holders. Instructions may be provided to each of the first and second key piece holders to add their respective key pieces to the blockchain database at a specified time.

In the embodiment described above, the plurality of key pieces may include other key pieces than the first and second key pieces. That is, the secret key may have been derived from other key pieces in addition the first and second key pieces. In some embodiments, the plurality of key pieces may comprise all key pieces that were used to derive the encryption key, or the plurality of key pieces may refer to a subset of the key pieces uses to derive the encryption key. Also, the plurality of key piece holders may comprise additional key piece holders other than the first and second key piece holders. That is, more than two key pieces holders may exist. In some embodiments, the trusted key holders may be automated services such as a web application. In such embodiments, the key holders may each be a different, independent web service. In such embodiments, each of the other additional key pieces may be distributed to different ones of the other key piece holders, and each of the other key pieces holders may be instructed to add the key piece they hold to the blockchain database at the specified time. In such embodiments, each of the additional key piece holders may be distributed one key piece or several key pieces, and in some embodiments, at least two different key piece holders hold different key pieces of the plurality of key pieces.

The specified time may be added to the blockchain database with other release data including the data to be released, i.e., the sensitive data encrypted with the encryption key derived from the plurality of key pieces. In some embodiments, executable release instructions may be added to and encoded in the blockchain that may cause a system to determine the encryption key using at least a threshold quantity of the plurality of key pieces added to the blockchain database by the key holders and decrypt the document at the specified release date. More specifically, the executable instructions may comprise instructions to determine if the release date has expired, and if so, to parse the blockchain and data stored thereon for block data comprising one or more of the key pieces. Once the function has identified a threshold quantity of key pieces needed to reconstruct the secret key, the function may reconstruct the secret key using the key derivation algorithm that was used to derive the secret key. Once the secret key is reconstructed, the executable code may cause the system to decrypt the sensitive data with the reconstructed encryption key. In certain embodiments, after decryption, the executable code may cause the system to add the decrypted document to the blockchain, thereby making it accessible. One of skill in the art appreciates that executable code may be written in blockchains and may provide opportunities for significant automation.

In some embodiments, one or more of the key piece holders may be the party intended to receive the sensitive information upon expiration of the release date. In such an embodiment, the instructions above may be provided to a key piece holder rather than, or in addition to, being written to the blockchain. In such embodiments, these release instructions are supplemental to instructions to add a key piece to the blockchain at he release date if the key piece holder which is intended to receive the sensitive information also holds one of the plurality of key pieces.

In some embodiments, the key pieces holders may be associated with a public-private key pair. In such embodiments, the public keys of the key piece holders may be written to the blockchain along with the release information. If so, the key piece holder may sign the key piece with their respective private key and write the signed key piece to the blockchain. By doing so, one is able to verify the authenticity of the authenticity of the key pieces by retrieving the key piece holders' public key information from the block written to the blockchain database containing the release information and use the public keys to decrypt the signed key piece so that only key pieces that come from the authentic key piece holders will be successfully decrypted.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
distributing a first key piece of a plurality of key pieces to a first key piece holder of a plurality of key piece holders, the plurality of key pieces being associated with an encryption key;
distributing a second key piece of the plurality of key pieces to a second key piece holder of the plurality of key piece holders;
adding release data to a blockchain database, wherein the release data comprises an identifier of sensitive data encrypted with the encryption key and a specified release date; and
providing instructions to the first key piece holder of the plurality of key piece holders to add the first key piece of the plurality of key pieces to the blockchain database at the specified release date, and providing instructions to the second key piece holder of the plurality of key pieces holders to add the second key piece of the plurality of key pieces to the blockchain database at the specified release date.

2. The method of claim 1, wherein the plurality of key pieces comprises additional key pieces other than the first and second key pieces, and the plurality of key piece holders comprise additional key piece holders other than the first and second key piece holders, and further comprising:
distributing each respective one of the additional key pieces to different respective ones of the additional key piece holders; and
instructing each additional key piece holder to add the respective one of the additional key pieces to the blockchain database at the specified release time.

3. The method of claim 2, wherein the plurality of key pieces comprises all key pieces that are associated with the encryption key.

4. The method of claim 1, further comprising adding release instructions associated with the release data to the blockchain database, wherein the release instructions comprise instructions that are executable to cause a system to determine the encryption key using at least a threshold quantity of the plurality of key pieces added to the blockchain database and decrypt the sensitive data with the encryption key at the specified release date.

5. The method of claim 1, further comprising adding release instructions associated with the release data to the blockchain database, wherein the release instructions comprise instructions that are executable to cause a system connected to a network associated with the blockchain database to perform operations comprising:
determining that a current date is equal to or later than the specified release date;
in response to determining that the current date is equal to or later than the specified release date, obtaining at least a threshold quantity of the plurality of key pieces from the blockchain database;
determining the encryption key from the at least a threshold quantity of the plurality of key pieces obtained from the blockchain database; and
decrypting the sensitive data using the determined encryption key.

6. The method of claim 1, further comprising instructing at least one key piece holder of the plurality of key piece holders to perform decryption operations comprising:
determining that a current date is equal to or later than the specified release date;
in response to determining that the current date is equal to or later than the specified release date, obtaining at least a threshold quantity of the plurality of key pieces from the blockchain database;
determining the encryption key from at least a threshold quantity of the plurality of key pieces obtained from the blockchain database; and
decrypting the sensitive data using the determined encryption key.

7. The method of claim 1, further comprising deriving the encryption key from the plurality of key pieces using an encryption function, wherein the encryption function is configured to allow the encryption key to be determined on or after the specified release date using fewer than all of the plurality of key pieces, and encrypting sensitive data with the encryption key.

8. The method of claim 2, wherein each key piece holder of the plurality of key piece holders is associated with a respective public key and a respective private key.

9. The method of claim 8, wherein the release data added to the blockchain database further comprises the respective public key associated with each key piece holder of the plurality of key piece holders.

10. The method of claim 9, wherein the first key piece is signed with a first private key associated with the first key piece holder and the second key piece is signed with a second private key associated with the second key piece holder.

11. A computer configured to access a storage device, the computer comprising:
a processor; and
a non-transitory, computer-readable storage medium storing computer-readable instructions that when executed by the processor cause the computer to perform:
deriving an encryption key from a plurality of key pieces using an encryption function, wherein the encryption function is configured to allow the encryption key to be determined on or after a specified release date using fewer than all of the plurality of key pieces;
encrypting sensitive data with the encryption key;
distributing a first key piece of the plurality of key pieces to a first key piece holder of a plurality of key piece holders, the plurality of key pieces being associated with an encryption key;
distributing a second key piece of the plurality of key pieces to a second key piece holder of the plurality of key piece holders;
adding release data to a blockchain database, wherein the release data comprises an identifier of sensitive data encrypted with the encryption key and a specified release date; and providing instructions to the first key piece holder of the plurality of key piece holders to add the first key piece of the plurality of key pieces to the blockchain database at the specified release date, and providing instructions to the second key piece holder of the plurality of key pieces holders to add the second key piece of the plurality of key pieces to the blockchain database at the specified release date.

12. The computer of clam 11, wherein the plurality of key pieces comprises additional key pieces other than the first and second key pieces, and the plurality of key piece holders comprise additional key piece holders other than the first and second key piece holders, and further comprising:
distributing each respective one of the additional key pieces to different respective ones of the additional key piece holders; and
instructing each additional key piece holder to add the respective one of the additional key pieces to the blockchain database at the specified release time.

13. The computer of clam 11, wherein the plurality of key pieces comprises all key pieces that are associated with the encryption key.

14. The computer of claim 11, wherein the computer-readable instructions further cause the computer to perform:
adding release instructions associated with the release data to the blockchain database, wherein the release instructions comprise instructions that are executable to cause a system to determine the encryption key using at least a threshold quantity of the plurality of key pieces added to the blockchain database and decrypt the sensitive data with the encryption key at the specified release date.

15. The computer of claim 11, wherein the computer-readable instructions further cause the computer to perform:
adding release instructions associated with the release data to the blockchain database, wherein the release instructions comprise instructions that are executable to cause a system connected to a network associated with the blockchain database to perform operations comprising:
determining that a current date is equal to or later than the specified release date;
in response to determining that the current date is equal to or later than the specified release date, obtaining at least a threshold quantity of the plurality of key pieces from the blockchain database;
determining the encryption key from the at least a threshold quantity of the plurality of key pieces obtained from the blockchain database; and
decrypting the sensitive data using the determined encryption key.

16. The computer of clam 11, wherein the computer-readable instructions further cause the computer to perform:
instructing at least one key piece holder of the plurality of key piece holders to perform decryption operations comprising:
determining that a current date is equal to or later than the specified release date;
in response to determining that the current date is equal to or later than the specified release date, obtaining at least a threshold quantity of the plurality of key pieces from the blockchain database;
determining the encryption key from at least a threshold quantity of the plurality of key pieces obtained from the blockchain database; and
decrypting the sensitive data using the determined encryption key.

17. The computer of clam 11, wherein each key piece holder of the plurality of key piece holders is associated with a respective public key and a respective private key.

18. The computer of claim 11, wherein the release data added to the blockchain database further comprises the respective public key associated with each key piece holder of the plurality of key piece holders.

19. The computer of claim 18, wherein the first key piece is signed with a first private key associated with the first key piece holder and the second key piece is signed with a second private key associated with the second key piece holder.

20. A computer program product comprising:
a computer-readable storage medium having computer-readable program code embodied therewith, the computer-readable program code comprising:
computer-readable program code configured to derive an encryption key from a plurality of key pieces using an encryption function, wherein the encryption function is configured to allow the encryption key to be determined on or after a specified release date using fewer than all of the plurality of key pieces;
computer-readable program code configured to encrypt sensitive data with the encryption key;
computer-readable program code configured to distribute a first key piece of the plurality of key pieces to a first key piece holder of a plurality of key piece holders, the plurality of key pieces being associated with an encryption key;
computer-readable program code configured to distribute a second key piece of the plurality of key pieces to a second key piece holder of the plurality of key piece holders;
computer-readable program code configured to add release data to a blockchain database, wherein the release data comprises an identifier of sensitive data encrypted with the encryption key and a specified release date;
computer-readable program code configured to provide instructions to the first key piece holder of the plurality of key piece holders to add the first key piece of the plurality of key pieces to the blockchain database at the specified release date, and providing instructions to the second key piece holder of the plurality of key pieces holders to add the second key piece of the plurality of key pieces to the blockchain database at the specified release date; and
computer-readable program code configured to add release instructions associated with the release data to the blockchain database, wherein the release instructions comprise instructions that are executable to cause a system to determine the encryption key using at least a threshold quantity of the plurality of key pieces added to the blockchain database and decrypt the sensitive data with the encryption key at the specified release date
